(19) United States
(12) Patent Application Publication
(10) Pub. No.: US 2025/0368930 A1
(43) Pub. Date: Dec. 4, 2025

(54) ADDITIVE FREE FLAVORED LIQUOR

(71) Applicant: TEQUILA WORKS, INC., Jensen Beach, FL (US)

(72) Inventor: Michael WINTERS, Jensen Beach, FL (US)

(73) Assignee: TEQUILA WORKS, INC., Jensen Beach, FL (US)

(21) Appl. No.: 18/875,625

(22) PCT Filed: Jun. 15, 2023
(86) PCT No.: PCT/US2023/068535

§ 371 Date: Dec. 16, 2024

Related U.S. Application Data
(60) Provisional application No. 63/352,511, filed on Jun. 15, 2022.

(51) Int. Cl. C12H 1/22; C12G 3/07

(52) U.S. Cl. CPC C12H 1/22; C12G 3/07

(57) ABSTRACT

The present disclosure relates to an additive free flavored tequila produced by an unflavored silver or Blanco tequila rested in a seasoned new oak barrel for at least a month to acquire a flavor imparted by the seasoned new oak barrel. The additive free flavored tequila is produced without the addition of any artificial flavors or additives, and the flavor is solely derived from the seasoned new oak barrel. The resulting additive free flavored tequila provides a unique and authentic taste experience for tequila enthusiasts. The present disclosure further relates to seasoned new oak barrel and method of making the seasoned new oak barrel.

### TECHNICAL FIELD

The present disclosure is directed to an additive free flavored liquor with flavoring imparted through an aging process using a seasoned new apparatus, seasoned new apparatus designed to make the additive free flavored liquor, a process of making the seasoned new apparatus, and a process of making the additive free flavored liquor using the seasoned new apparatus.

### BACKGROUND

Flavored liquors are increasing in popularity. Traditionally, flavored liquors are produced by adding flavoring additives to native liquors to impart different flavors. For example, additives such as herb or fruit flavors can be added into liquors to impart herbal or fruity flavor. Paradoxically however, liquor without additives is generally perceived to be superior in quality. There is therefore a need for additive free flavored liquor that is superior in quality and flavor.

### SUMMARY

In a first aspect, the present disclosure is directed to an additive free flavored tequila, including an unflavored silver or Blanco tequila having rested in a seasoned new oak barrel for at least a month to acquire a flavor imparted by the seasoned new oak barrel to form the additive free flavored tequila. In one embodiment, the unflavored silver or Blanco tequila is rested in the seasoned new oak barrel for less than two months to produce an additive free flavored silver or Blanco tequila. In one embodiment, the unflavored silver or Blanco tequila is rested in the seasoned new oak barrel for at least two months and less than a year to produce an additive free flavored aged or reposado tequila. In one embodiment, the unflavored silver or Blanco tequila is rested in the seasoned new oak barrel for at least a year and less than three years to produce an additive free flavored extra-aged or Añejo tequila. In one embodiment, the unflavored silver or Blanco tequila is rested in the seasoned new oak barrel for at least three years to produce an additive free flavored ultra-aged or extra Añejo tequila. In one embodiment, the seasoned new oak barrel is seasoned with a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor.

In another aspect, the present disclosure is directed to a seasoned new oak barrel having been seasoned with a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor. In one embodiment, the seasoned new oak barrel is produced by filling a new char oak barrel with a seasoning solution and letting the seasoning solution resting in the new char oak barrel for at least 10 days to season the new char oak barrel to produce the seasoned new oak barrel, and the seasoning solution includes a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor. In one embodiment, the seasoning solution rests in the new char oak barrel for 30 days at room temperature to season the new char oak barrel to produce the seasoned new oak barrel.

In a further aspect, the present disclosure is directed to a method to produce an additive free flavored liquor, the method including resting an unflavored liquor in the seasoned new oak barrel for at least a month to acquire a flavor imparted by the seasoned new oak barrel to form the additive free flavored liquor. In one embodiment, the unflavored liquor is selected from the group consisting of whiskey, bourbon, vodka, gin, rum, and brandy. In one embodiment, the unflavored liquor is rested in the seasoned new oak barrel for at least three months to acquire the flavor imparted by the seasoned new oak barrel to form the additive free flavored liquor.

In an additional aspect, the present disclosure is directed to a method to produce an additive free flavored tequila, the method including: resting an unflavored silver or Blanco tequila in a seasoned new oak barrel for at least a month to acquire a flavor imparted by the seasoned new oak barrel to produce the additive free flavored tequila. In one embodiment, the method includes resting the unflavored silver or Blanco tequila in the seasoned new oak barrel for less than two months to produce an additive free flavored silver or Blanco tequila. In one embodiment, the method includes resting the unflavored silver or Blanco tequila in the seasoned new oak barrel for at least two months and less than a year to produce an additive free flavored aged or reposado. In one embodiment, the method includes resting the unflavored silver or Blanco tequila in the seasoned new oak barrel for at least a year and less than three years to produce an additive free flavored extra-aged or Añejo tequila. In one embodiment, the method includes resting the unflavored silver or Blanco tequila in the seasoned new oak barrel for at least three years to produce an additive free flavored ultra-aged or Extra Añejo tequila. In one embodiment, the method further includes filtering the additive free flavored tequila. In one embodiment, the method further includes filling a new oak barrel with a seasoning solution and letting the seasoning solution resting in the new oak barrel for at least 10 days to season the new oak barrel to produce the seasoned new oak barrel, and the seasoning solution includes a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor. In one embodiment, the new oak barrel is medium charred and the seasoning solution rests in the new medium charred oak barrel for 30 days at room temperature to season the new medium charred oak barrel to produce the seasoned new oak barrel.

### BRIEF DESCRIPTION OF THE DRAWINGS

The figures disclosed herein are not necessarily to scale and certain features may be shown exaggerated in scale or in a somewhat generalized schematic form in the interest of clarity and conciseness. For the complete understanding of the features and advantages of the present disclosure, reference is now made to the detailed description along with the accompanying figures, wherein:

FIG. 1 is picture of agave tequilana.

FIG. 2 is a picture of agave piñas or “pineapples”.

FIG. 3 is a picture of tequila being rested or aged in oak barrels.

FIG. 4 is a flow chart of a method to produce the additive free flavored tequilas disclosed herein.

FIG. 5 is a flow chart of a method to produce the seasoned new oak barrel disclosed herein.

FIG. 6 is a flow chart of a method to produce the additive free flavored tequilas disclosed herein with the additional step(s) of producing the seasoned new oak barrel.

### DETAILED DESCRIPTION

The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a composition that “comprises,” “has,” “includes” or “contains” one or more elements possesses those one or more elements but is not limited to possessing only those elements. Likewise, a method that “comprises,” “has,” “includes” or “contains” one or more steps possesses those one or more steps but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

The present disclosure may be understood more readily by reference to the following detailed description of embodiments and to the Figures and their previous and following description.

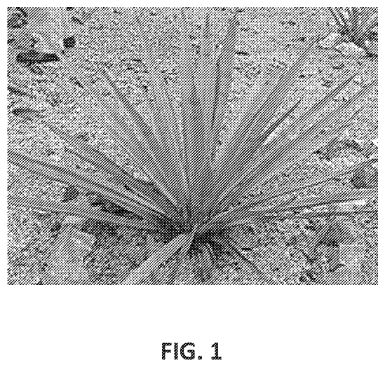

The original poor man's liquor, a.k.a Tequila, is a spirit that has rapid increasing international popularity. With the popularity, comes constant pressure to maintain its identity. To sustain Tequila products' quality and status, the country of Tequila's origin, Mexico has devoted many resources and measures. For example, Tequila has gained trademark protection to protect its identity. Accordingly, Tequila is specified as a distilled beverage made from the blue agave plant, Agave tequilana, primarily produced in the area surrounding the city of Tequila 65 km (40 mi) northwest of Guadalajara, and in the Jaliscan Highlands (Los Altos de Jalisco) of the central western Mexican state of Jalisco. A picture of a blue agave plant, Agave tequilana is shown in FIG. 1.

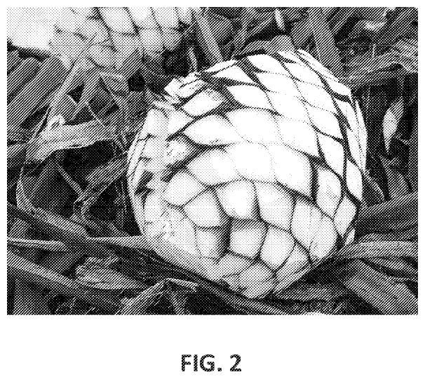

To make tequila, the leaves of the blue agave plant are first cut off to harvest the succulent core of the plant, or piñas, as shown in FIG. 2. After harvesting, the piñas are slowly baked before being either shredded or mashed to produce a pulp. The fiber in the pulp is then removed to produce extracted agave juice, which is then poured into large vessels to ferment for a few days, resulting in a wort, or misto, with low alcohol content. This wort is then distilled once to produce what is called ordinario, and then the ordinaries is distilled to produce clear “silver” tequila or blanco.

Using at least two distillations after fermentation is required by law to produced tequila. As well, the spirit must contain 38-55% alcohol content, which is fermented from a wort that contains no less than 51% sugars from the blue agave plant. Silver/Blanco tequila provides the purest form as little aging has occurred. In general, Silver/Blanco tequila are normally aged less than two months. Silver/Blanco tequila can also be aged in wooden containers to impart color and aroma. The aging process can last less than two months, at least two months to one year, between one year and three years, or at least three years. The aging process generally imparts a golden color to tequila and can create or enhance aromas.

Tequilas fall under two general categories: mixto and 100% agave (100% De Agave or 100%). Mixto normally is not displayed on the bottle label of a tequila. But if “100% Agave” is not displayed, it is most likely a mixto. This type of tequila is distilled from a mix of at least 51% sugars deriving from the blue agave plant along with other sugars such as cane sugar. Mixto tequilas are inexpensive and include some of the most popular-selling tequila brands, such as Jose Cuervo Gold and Sauza. 100% agave (100% De Agave or 100%) tequilas are distilled completely from fermented 100% blue agave. The 100% agave tequilas are more expensive but considered superior to mixtos in quality and flavor. 100% agave tequila brands include Patron, Herradura, Don Julio, and Cazadores. Either mixto or 100% agave tequila may fall into one of the following aging categories.

Depending on the length of the aging process, tequila that has gone through the aging process fall into the following three categories. Reposado (“rested”) is Silver/Blanco tequila after aged a minimum of two months, but less than a year in oak barrels of any size. Añejo (“aged” or “vintage”) is Silver/Blanco tequila aged a minimum of one year, but less than three years in oak barrels. A category newly established in March 2006 is Extra Añejo (“extra aged” or “ultra-aged”), which is Silver/Blanco tequila after aged a minimum of three years in oak barrels. For the ease of discussion, all three categories of the silver/blanco tequila that have gone through the aging process will be called aged tequila in this application. Añejo Tequila and Extra Añejo Tequila are oftentimes collectively called Añejo Tequila, referring to silver or blanco tequila that has been aged for at least one year.

Aged tequila must be matured in oak barrels. There are, however, more than 50 different companies producing tequila in the Mexican province of Jalisco, with different maturation times according to the variety of tequila and desired quality of the final product. All companies producing tequila have their aging processes regulated by the Mexican government.

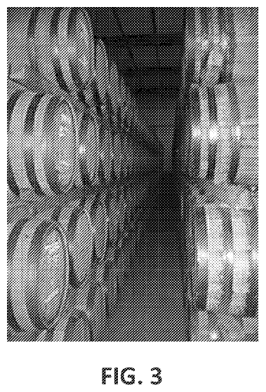

Reposado may be rested in oak barrels or casks as large as 20,000 liters (5,280 gallons), allowing for richer and more complex flavors. A picture of oak barrels typically used in producing tequila is shown in FIG. 3. Some reposados can also be aged in new wood barrels to achieve the same woody flavor and smoothness, but in less time.

The preferred oak to make oak barrels comes from the US, France, or Canada, and is usually white oak. Some companies char the wood to impart a smoky flavor or use barrels previously used to rest different kinds of alcohol such as whiskey or wine. Barrels previously used to rest different kinds of alcohol such as whiskey or wine are not considered new oak barrels. Instead, these barrels are considered to be used oak barrels. The flavor imparted in the tequila by the new, charred, or previously used oak barrels are not considered to be strong enough to generate a flavored tequila. Instead, tequila's aged in the new, charred, or previously used oak barrels are generally considered to be unflavored tequila.

Añejos are often rested in barrels previously used to rest Reposados. The barrels cannot be more than 600 liters (158 gallons), and most are in the 200-liter (52-gallon) range. Many of the barrels used are from whiskey distilleries in the US or Canada, and Jack Daniels barrels are especially popular. This treatment creates many of the aspects of the dark color and more complex flavors of the añejo tequila. After aging of at least one year, the añejo can be removed from the wood barrels and placed in stainless steel tanks to reduce the amount of evaporation that can occur in the barrels. Aged tequila may also be a blend of silver tequila and aged tequila.

The Norma Oficial Mexicana (NOM) issued by the Mexico government applies to all processes and activities related to the supply of agave, production, bottling, marketing, information, and business practices linked to the distilled alcoholic beverage known as tequila. Tequila must be produced using agave of the species Tequilana Weber Blue variety, grown in the federal states and municipalities indicated in the NOM. The important laws since 1990 were NOM-006-SCFI-1993, the later updates NOM-006-SCFI-1994 and NOM-006-SCFI-2005 and the most recent revision published on Dec. 13, 2012, NOM-006-SCFI-2012. The NOM-006-SCFI-2012 is incorporated herein by reference.

All authentic, regulated tequilas will have a NOM identifier on the bottle. The number after NOM is the distillery number, assigned by the government. NOM does not indicate the location of the distillery, merely the parent company or, in the case where a company leases space in a plant, the physical plant where the tequila was manufactured.

According to NOM, tequila is classified in one of the following two categories, based on the percentage of natural Agave sugars used in its production. “100% agave” tequila is a product whose fermentation may not be enhanced with sugars other than those obtained from the tequilana weber blue variety Agave grown in the territory specified. For the product to be considered “100% agave” Tequila, it must be bottled in the bottling plant controlled by an Authorized Producer, which must be located within the territory specified. This product must be labeled using one of the following statements: “100% de agave,” “100% puro de agave,” “100% agave,” or “100% puro agave,” to which the word “azul” [“blue”] may be added.

“Tequila” on the other hand, may be enhanced and blended together prior to fermentation with other sugars in a proportion not to exceed 49% of total reducing sugars expressed in units of mass. This maximum enhancement of up to 49% of total reducing sugars expressed in units of mass may not be done with sugars from any species of Agave. The 51% of total reducing sugars expressed in units of mass may only be enhanced with tequilana weber blue variety Agave grown in the territory specified. This product may be bottled in plants not belonging to an authorized producer under strict compliance by the bottler of the conditions.

Based on the characteristics acquired in processes subsequent to distillation, Tequila is classified as: Blanco or Plata; Joven or Oro, Reposado, Añejo, Extra Añejo. For the international market, the classification mentioned in the foregoing paragraph may be substituted by the translation to the applicable language according to the regulation of the country or place of commercialization or by the following: “Silver” for Blanco or Plata, “Gold” for Joven or Oro, “Aged” for Reposado, “Extra-aged” for Añejo, Ultra-aged for Extra Añejo.

Specifically, silver Tequila (Blanco) is a transparent product not necessarily colorless, without additives, obtained through distillation, whose commercial alcohol content must be adjusted by dilution with water and other provisions in the cases that apply; possibly having an aging process of less than two months in oak or Encino oak containers.

Gold Tequila (Joven or Oro) is a product resulting of the mix between white Tequila with aged, extra-aged or ultra-aged Tequilas. Also called Tequila joven or gold is the product that results from blending silver Tequila with any of the ingredients such as Caramel coloring, Natural oak or Encino oak extract (holm or holm oak extract), Glycerin, and Sugar-based syrup in what is known as mellowing.

Aged Tequila (Reposado) is a product which may be enhanced by mellowing, subject to an aging process of at least two months in direct contact with the wood of oak or Encino oak (holm or holm oak) containers. Its commercial alcohol content must be adjusted by dilution with water, as applicable. The result of blending aged Tequila with extra-aged Tequila is considered aged Tequila.

Extra-aged Tequila (Añejo) is a product that may be enhanced by mellowing, subject to an aging process of at least one year in direct contact with the wood of oak (holm or holm oak) or Encino oak containers with a maximum capacity of 600 liters. Its commercial alcohol content must be adjusted by dilution with water. The result of blending extra-aged Tequila with ultra-aged Tequila is considered extra-aged Tequila.

Ultra-aged Tequila (Extra Añejo) is a product that may be enhanced by mellowing, subject to an aging process of at least three years, in direct contact with the wood of the oak or Encino oak containers, whose maximum capacity is 600 liters, its commercial alcohol content must be adjusted with dilution water.

In recent years, flavored tequila becomes popular in countries such as US. Although silver/blanco tequila and aged tequila may incorporate other ingredients, such as the addition of grain alcohols, caramel color, or flavors. Paradoxically, in the tequila industry, tequila without additives is generally considered superior in quality and flavor. Disclosed herein are additive free flavored 100% agave tequila that is superior in quality and flavor, thus overcome the paradox. Disclosed herein are also methods and process of making additive free flavored 100% agave tequila. The methods and process disclosed herein to make additive free flavored 100% agave tequila can be adapted to make other additive free flavored liquor as well, including whiskey, bourbon, vodka, gin, rum, brandy, and alike.

Specifically, oak barrels are first treated with flavoring agents, such as coffee flavor to produce seasoned new oak barrel. The seasoned new oak barrel disclosed herein therefore are relatively new oak barrels treated with a solution of flavoring agent. These seasoned new oak barrel differ from the traditional, new, charred, or used oak barrel in that, it is new oak barrel treated with a solution of flavoring agent, and thus is not the same as a untreated new oak barrel. Similar reasoning goes for the charred oak barrel. The difference between seasoned new oak barrel disclosed herein and used oak barrel is that the seasoning solution does not rest in the oak barrel for more than a year, and therefore is still considered new relative to the used oak barrels, where the previously contained whisky or wine rests more than a year. Additionally, the seasoning solution used to season the new oak barrel does not have a significant amount of alcohol. In comparison, either whisky or wine rested in the used oak barrel has a significant amount of alcohol. In one embodiment, the seasoning solution used herein is free of alcohol. In another embodiment, the seasoning solution used herein contains less than 1% v/v alcohol. In one embodiment, the seasoning solution used herein contains less than 2, 3, 4, or 5% v/v alcohol.

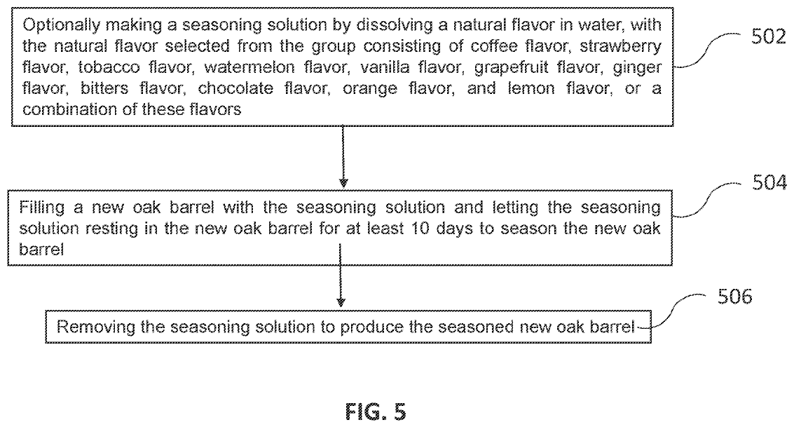

Referring to FIG. 5, a process of making a seasoned new oak barrel is shown, comprising steps 504, 506, and optional step 502. Step 504 comprises filling a new oak barrel with a seasoning solution and letting the seasoning solution resting in the new oak barrel for at least 10 days to season the new oak barrel. Step 506 comprises removing the seasoning solution from the oak barrel to produce the seasoned new oak barrel. The process optional includes step 502, which comprises making a seasoning solution by dissolving a natural flavor in water, with the natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor, or a combination of these flavors. The seasoning solution produced in step 502 is then used in step 504 to produce a seasoned new oak barrel. Details of natural flavors can be found in various publicly available sources, for example, “Flavourings: Production, Composition, Applications, Regulations. Germany: Wiley, 2008 by Erich Ziegler, Herta Ziegler”, which is incorporated herein by reference.

In one embodiment, 100% Organic Mexican Coffee is directly cold brewed into new medium char barrels filling all 53 gallons to season a new oak barrel. In one embodiment, the coffee to water ratio is 1 g to 20 mL in the cold coffee brew, for example a brew made from 25 lb. of coffee in 60 gallons of water. In some embodiments, the coffee to water ratio in the coffee brew is between 0.2 g to 20 mL to 10 g to 20 mL such as between 0.2 g to 20 mL to 0.4 g to 20 mL, 0.4 g to 20 mL to 0.8 g to 20 mL, 0.8 g to 20 mL to 1.2 g to 20 mL, 1.2 g to 20 mL to 1.6 g to 20 mL, 1.6 g to 20 mL to 2.0 g to 20 mL, 2.0 g to 20 mL to 2.4 g to 20 mL, 2.4 g to 20 mL to 2.8 g to 20 mL, 2.8 g to 20 mL to 3.2 g to 20 mL, 3.2 g to 20 mL to 3.6 g to 20 mL, 3.6 g to 20 mL to 4 g to 20 mL, 4 g to 20 mL to 4.4 g to 20 mL, and 4.4 g to 20 mL to 4.8 g to 20 mL, 4.8 g to 20 mL to 5.2 g to 20 mL, 5.2 g to 20 mL to 5.6 g to 20 mL, 5.6 g to 20 mL to 6 g to 20 mL, 6 g to 20 mL to 6.4 g to 20 mL, 6.4 g to 20 mL to 6.8 g to 20 mL, 6.8 g to 20 mL to 7.2 g to 20 mL, 7.2 g to 20 mL to 7.6 g to 20 mL, 7.6 g to 20 mL to 8 g to 20 mL, 8 g to 20 mL to 8.4 g to 20 mL, 8.4 g to 20 mL to 8.8 g to 20 mL, 8.8 g to 20 mL to 9.2 g to 20 mL, or 9.2 g to 20 mL to 9.8 g to 20 mL.

In one embodiment, strawberry flavor is used to produce the seasoning solution disclosed herein. In one embodiment, the strawberry flavor to added water ratio in the seasoning solution is 1 g to 20 mL. In some embodiments, the strawberry flavor to water ratio is between 0.2 g to 20 mL to 10 g to 20 mL such as between 0.2 to 20 mL to 0.4 g to 20 mL, 0.4 to 20 mL to 0.8 g to 20 mL, 0.8 to 20 mL to 1.2 g to 20 mL, 1.2 to 20 mL to 1.6 g to 20 mL, 1.6 to 20 mL to 2.0 g to 20 mL, 2.0 to 20 mL to 2.4 g to 20 mL, 2.4 to 20 mL to 2.8 g to 20 mL, 2.8 to 20 mL to 3.2 g to 20 mL, 3.2 to 20 mL to 3.6 g to 20 mL, 3.6 g to 20 mL to 4 g to 20 mL, 4 to 20 mL to 4.4 g to 20 mL, and 4.4 g to 20 mL to 4.8 g to 20 mL, 4.8 g to 20 mL to 5.2 g to 20 mL, 5.2 g to 20 mL to 5.6 g to 20 mL, 5.6 g to 20 mL to 6 g to 20 mL, 6 g to 20 mL to 6.4 g to 20 mL, 6.4 g to 20 mL to 6.8 g to 20 mL, 6.8 to 20 mL to 7.2 g to 20 mL, 7.2 to 20 mL to 7.6 g to 20 mL, 7.6 g to 20 mL to 8 g to 20 mL, 8 g to 20 mL to 8.4 g to 20 mL, 8.4 to 20 mL to 8.8 g to 20 mL, 8.8 to 20 mL to 9.2 g to 20 mL, or 9.2 g to 20 mL to 9.8 g to 20 mL.

In one embodiment, vanilla extract is used to produce the seasoning solution disclosed herein. In one embodiment, the vanilla extract to added water ratio in the seasoning solution is 1 mL to 20 mL, or 5% v/v. In some embodiments, the vanilla extract to added water ratio in the seasoning solution is between 0.02 mL to 20 mL to 5 mL to 20 mL such as between such as between 0.02 mL to 20 mL to 0.4 mL to 20 mL, 0.4 mL to 20 mL to 0.8 mL to 20 mL, 0.8 mL to 20 mL to 1.2 mL to 20 mL, 1.2 mL to 20 mL to 1.6 mL to 20 mL, 1.6 mL to 20 mL to 2.0 mL to 20 mL, 2.0 mL to 20 mL to 2.4 mL to 20 mL, 2.4 mL to 20 mL to 2.8 mL to 20 mL, 2.8 mL to 20 mL to 3.2 mL to 20 mL, 3.2 mL to 20 mL to 3.6 mL to 20 mL, 3.6 mL to 20 mL to 4 mL to 20 mL, 4 mL to 20 mL to 4.4 mL to 20 mL, and 4.4 mL to 20 mL to 4.8 mL to 20 mL, 4.8 mL to 20 mL to 5.2 mL to 20 mL.

In one embodiment, one of more seasoning(s) selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor is used to produce the seasoning solution disclosed herein. In one embodiment, the selected seasoning(s) to added water ratio in the seasoning solution is 1 g to 20 mL. In some embodiments, the selected seasoning(s) to water ratio is between 0.2 g to 20 mL to 10 g to 20 mL such as between 0.2 to 20 mL to 0.4 g to 20 mL, 0.4 to 20 mL to 0.8 g to 20 mL, 0.8 to 20 mL to 1.2 g to 20 mL, 1.2 to 20 mL to 1.6 g to 20 mL, 1.6 to 20 mL to 2.0 g to 20 mL, 2.0 to 20 mL to 2.4 g to 20 mL, 2.4 to 20 mL to 2.8 g to 20 mL, 2.8 to 20 mL to 3.2 g to 20 mL, 3.2 to 20 mL to 3.6 g to 20 mL, 3.6 g to 20 mL to 4 g to 20 mL, 4 to 20 mL to 4.4 g to 20 mL, and 4.4 g to 20 mL to 4.8 g to 20 mL, 4.8 g to 20 mL to 5.2 g to 20 mL, 5.2 g to 20 mL to 5.6 g to 20 mL, 5.6 g to 20 mL to 6 g to 20 mL, 6 g to 20 mL to 6.4 g to 20 mL, 6.4 g to 20 mL to 6.8 g to 20 mL, 6.8 to 20 mL to 7.2 g to 20 mL, 7.2 to 20 mL to 7.6 g to 20 mL, 7.6 g to 20 mL to 8 g to 20 mL, 8 g to 20 mL to 8.4 g to 20 mL, 8.4 to 20 mL to 8.8 g to 20 mL, 8.8 to 20 mL to 9.2 g to 20 mL, or 9.2 g to 20 mL to 9.8 g to 20 mL.

The seasoning solution disclosed above has a resting time inside the new oak barrel at certain temperature to ensure proper seasoning of the new oak barrels. In one embodiment, the resting time is 30 days at room temperature. In another embodiment, the resting time is 10-15 days, 15-20 days, 20-25 days, 25-30 days, 30-35 days, 35-40 days, 40-45 days, 45-50 days, 50-55 days, 55-60 days, 60-65 days, 65-70 days, 70-75 days, 75-80 days, 80-85 days, 85-90 days, 90-95 days, 95-100 days, 100-105 days, 105-110 days, 110-115 days, 115-120 days, 120-125 days, 125-130 days, 130-135 days, 135-140 days, 140-145 days, 145-150 days, 150-155 days, 155-160 days, 160-165 days, 165-170 days, 170-175 days, 175-180 days, 180-185 days, 185-190 days, 190-195 days, 195-200 days, 200-205 days, 205-210 days, 210-215 days, 215-220 days, 220-215 days, 215-220 days, 220-225 days, 225-230 days, 230-235 days, 235-240 days, 240-245 days, 245-250 days, 250-260 days, 260-265 days, or 265-270 days. In one embodiment, the resting time of the seasoning solution inside the new oak barrel is less than a year. In one embodiment, the resting temperature is 5-10° C., 10-15° C., 15-20° C., 20-25° C., 25-30° C., or 30-35° C. In one embodiment, the seasoning solution is coffee brew and has a resting time inside the new oak barrel of 30 days at room temperature to produce a coffee seasoned new oak barrel. In one embodiment, the seasoning solution is strawberry and has a resting time inside the new oak barrel of 30 days at room temperature to produce a strawberry seasoned new oak barrel. In one embodiment, the seasoning solution is vanilla and has a resting time inside the new oak barrel of 30 days at room temperature to produce a vanilla seasoned new oak barrel.

In one embodiment, the oak barrel used to produce the seasoned new oak barrel is pretreated with a charring process commonly known in the oak barrel industry and referred to as charred oak barrel. In one embodiment, the oak barrel used to produce the seasoned new oak barrel is pretreated with a charring process to produce medium charred oak barrel. In another embodiment, the oak barrel used to produce the seasoned new oak barrel is not charred or pretreated. Once the resting time inside the new oak barrel, for example, 30-days is completed, the seasoning solution such as cold brew coffee is emptied and discarded, leaving only the wood-soaked seasoning behind in the barrel. Disclosed herein are seasoned new barrels, for example seasoned new oak barrels. And the seasonings are selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor. It should be noted that a combination of seasonings outlined above can be used as well, for example, Vanilla Coffee flavor, Chocolate Coffee flavor, or Lemon Lime flavor. In general, seasoning solutions are produced from the seasonings outlined above by dissolving natural seasonings outlined above in water. In some embodiments, after the resting time, for example, 30-days is completed, the seasoning solution such as cold brew coffee is emptied and discarded, leaving only the wood-soaked seasoning behind in the barrel.

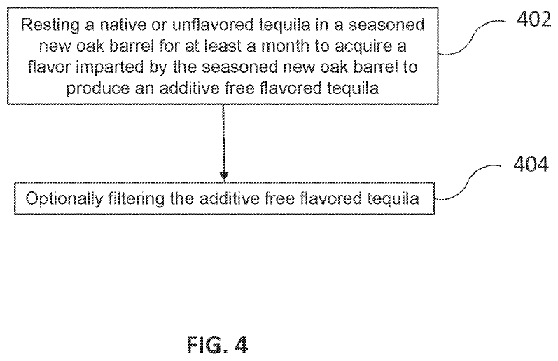

100% agave tequila is then aged inside the seasoned new oak barrel such as a coffee seasoned new oak barrel to produce additive free flavored 100% agave tequila, for example additive free coffee flavored 100% agave tequila. Referring to FIG. 4, a process of making an additive free flavored tequila is shown, comprising a step 402 with an optional step 404. Step 402 comprises resting a native or unflavored tequila in a seasoned new oak barrel for at least a month to acquire a flavor imparted by the seasoned new oak barrel to produce a rested additive free flavored tequila. Optional step 404 comprises filtering the rested additive free flavored tequila to produce an additive free flavored tequila.

In one embodiment, the native or unflavored silver or Blanco tequila is rested in the seasoned new oak barrel for less than two months to produce an additive free flavored silver or Blanco tequila. In one embodiment, the native or unflavored silver or Blanco tequila is rested in the seasoned new oak barrel for at least two months and less than a year to produce an additive free flavored aged or reposado tequila. In one embodiment, the native or unflavored silver or Blanco tequila is rested in the seasoned new oak barrel for at least a year and less than three years to produce an additive free flavored extra-aged or Añejo tequila. In one embodiment, the native or unflavored silver or Blanco tequila is rested in the seasoned new oak barrel for at least three years to produce an additive free flavored ultra-aged or extra Añejo tequila.

In one embodiment, the native or unflavored silver or Blanco tequila is rested in a coffee flavor seasoned new oak barrel for less than two months to produce an additive free coffee flavored silver or Blanco tequila. In one embodiment, the native or unflavored silver or Blanco tequila is rested a coffee flavor seasoned new oak barrel for at least two months and less than a year to produce an additive free coffee flavored aged or reposado tequila. In one embodiment, the native or unflavored silver or Blanco tequila is rested in a coffee flavor seasoned new oak barrel for at least a year and less than three years to produce an additive free coffee flavored extra-aged or Añejo tequila. In one embodiment, the native or unflavored silver or Blanco tequila is rested in a coffee flavor seasoned new oak barrel for at least three years to produce an additive free coffee flavored ultra-aged or extra Añejo tequila.

In one embodiment, these silver or Blanco tequila filled barrels are stored in the distillery cellar at room temperature such as 45-65 degrees Fahrenheit for a resting period, for example, for 5 months to conduct the aging process. During the resting period such as 5 months, the barrels are left untouched to produce the additive free flavored 100% agave tequila. In some embodiments, after resting period such as 5 months, the flavored 100% agave tequila goes through a cold filtration process to remove any unwanted settlement or particles left behind from the aging process. Because the flavor is introduced through its container for aging and not direct addition into the tequila itself, the flavored 100% agave tequila disclosed herein is considered additive free. In one embodiment, the resting period of the unflavored tequila in the seasoned new oak barrel to impart flavor is 1-5 weeks, 5-10 weeks, 10-15 weeks, 15-20 weeks, 20-25 weeks, 25-30 weeks, 30-35 weeks, 35-40 weeks, 40-45 weeks, 45-50 weeks, 50-55 weeks, 55-60 weeks, 60-65 weeks, 65-70 weeks, 75-80 weeks, 80-85 weeks, 85-90 weeks, 90-95 weeks, 95-100 weeks, 100-105 weeks, 105-110 weeks, 115-120 weeks, 120-125 weeks, 125-130 weeks, 130-135 weeks, 135-140 weeks, 140-145 weeks, 145-150 weeks, 150-155 weeks, 155-160 weeks, 160-170 weeks, 170-180 weeks, 180-185 weeks, 185-190 weeks, 190-200 weeks, 200-210 weeks, 210-220 weeks, 220-230 weeks, 230-240 weeks, 240-250 weeks, 250-260 weeks, 260-270 weeks, 270-295 weeks, 295-320 weeks, 320-345 weeks, 370-395 weeks, 395-420 weeks, 420-445 weeks, 470-495 weeks, 495-520 weeks, or 520-545 weeks. In one embodiment, the resting temperature to impart flavor to the native or unflavored tequila is 5-10° C., 10-15° C., 15-20° C., 20-25° C., 25-30° C., or 30-35° C.

In some embodiment, the processes and methods disclosed herein can be used to add flavor to tequilas that are not 100% agave to produce additive free flavored tequila that are not 100% agave. In some embodiment, the processes and methods disclosed herein can be used to add flavor to misto tequilas to produce additive free flavored misto tequila.

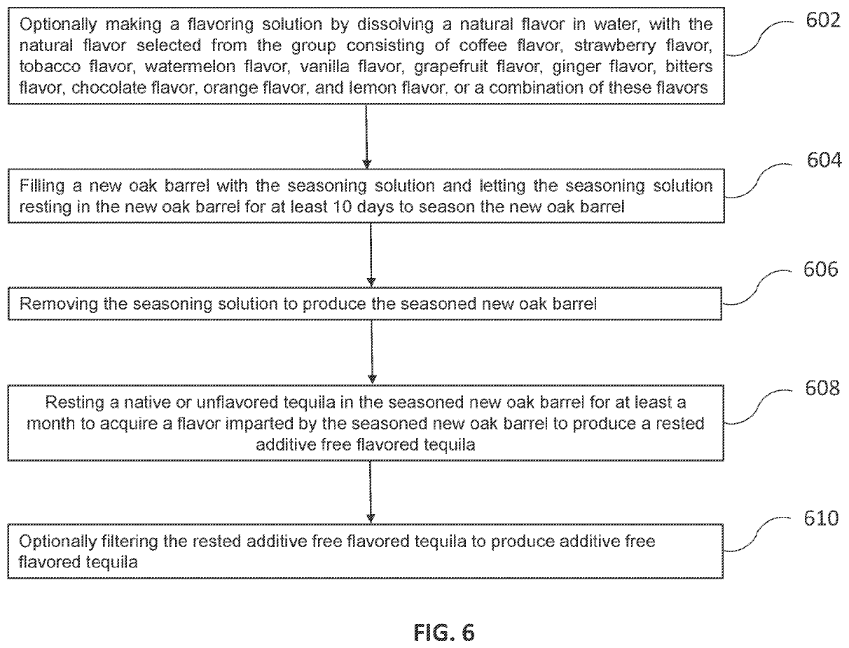

Referring to FIG. 6, a process of making an additive free flavored tequila including the process of making a seasoned new oak barrel is shown, comprising the steps 604, 606, and 608 with optional steps 602 and 610. Step 604 comprises filling a new oak barrel with a seasoning solution and letting the seasoning solution resting in the new oak barrel for at least 10 days to season the new oak barrel. Step 606 comprises removing the seasoning solution from the oak barrel to produce the seasoned new oak barrel. The process optional includes step 602, which comprises making a seasoning solution by dissolving a natural flavor in water, with the natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor, or a combination of these flavors. The seasoning solution produced in step 602 is then used in step 604 to produce a seasoned new oak barrel. Step 608 comprises resting a native or unflavored tequila in a seasoned new oak barrel for at least a month to acquire a flavor imparted by the seasoned new oak barrel to produce a rested additive free flavored tequila. Optional step 610 comprises filtering the rested additive free flavored tequila of step 608 to produce an additive free flavored tequila.

In one embodiment, the new oak barrel is a reconditioned new oak barrel. The reconditioning process is conducted by stripping a used seasoned oak barrel to remove the top layer to reveal new oak wood to produce a reconditioned new oak barrel. In one embodiment, the reconditioning process is conducted by stripping a used seasoned oak barrel to remove the top layer to reveal new oak wood followed by charring the new oak wood to produce a reconditioned new oak barrel. In one embodiment, the used seasoned oak barrel is the seasoned new oak barrel after the resting step of 402 or 608.

The methods and processes disclosed herein can be used for other additive free liquors as well. For example, oak barrel flavored with grapefruit can be used to contain vodka to produce grapefruit flavored vodka. For another example, oak barrel flavored with tobacco or cigar can be used to age or rest whisky or bourbon to produce tobacco or cigar flavored whisky or bourbon. The methods and processes disclosed herein have to the applicant's knowledge never been done before. There are NO brands of Tequila that are 100% Blue agave, additive free, flavored Tequila. In one embodiment, the additive free flavored 100% agave tequila is organic.

A 100% Agave, additive free flavored Tequila is a new addition to the family of flavored Tequilas. All Flavored Tequilas up to this point tend to be heavily sugary and additive loaded drinks. In contrast, because the flavor is not introduced by addition directly into liquor itself but by aging, the 100% Agave additive free flavored Tequila disclosed herein imparts a distinct flavor and aroma picked up from the tenant in the seasoned new oak barrel and is free of heavy sugar and additives.

The embodiments above are intended to be illustrative and not limiting. Additional embodiments are within the claims. In addition, although the present disclosure has been described with reference to particular embodiments, those skilled in the art will recognize that changes can be made in form and detail without departing from the spirit and scope of the disclosure. Any incorporation by reference of documents above is limited such that no subject matter is incorporated that is contrary to the explicit disclosure herein.

We claim:

1. An additive free flavored tequila, comprising an unflavored silver or Blanco tequila having rested in a seasoned new oak barrel for at least a month to acquire a flavor imparted by the seasoned new oak barrel to form the additive free flavored tequila.

2. The additive free flavored tequila of claim 1, wherein the unflavored silver or Blanco tequila is rested in the seasoned new oak barrel for less than two months to produce an additive free flavored silver or Blanco tequila.

3. The additive free flavored tequila of claim 1, wherein the unflavored silver or Blanco tequila is rested in the seasoned new oak barrel for at least two months and less than a year to produce an additive free flavored aged or reposado tequila.

4. The additive free flavored tequila of claim 1, wherein the unflavored silver or Blanco tequila is rested in the seasoned new oak barrel for at least a year and less than three years to produce an additive free flavored extra-aged or Añejo tequila.

5. The additive free flavored tequila of claim 1, wherein the unflavored silver or Blanco tequila is rested in the seasoned new oak barrel for at least three years to produce an additive free flavored ultra-aged or extra Añejo tequila.

6. The additive free flavored tequila of claim 1, wherein the seasoned new oak barrel is seasoned with a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor.

7. A seasoned new oak barrel having been seasoned with a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor.

8. The seasoned new oak barrel of claim 7, wherein the seasoned new oak barrel is produced by filling a new char oak barrel with a seasoning solution and letting the flavoring solution resting in the new char oak barrel for at least 10 days to season the new char oak barrel to produce the seasoned new oak barrel, and the seasoning solution comprises a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor.

9. The seasoned new oak barrel of claim 8, wherein the seasoning solution rests in the new char oak barrel for 30 days at room temperature to season the new char oak barrel to produce the seasoned new oak barrel.

10. A method to produce an additive free flavored liquor, the method comprising: resting an unflavored liquor in the seasoned new oak barrel of claim 7 for at least a month to acquire a flavor imparted by the seasoned new oak barrel to form the additive free flavored liquor.

11. The method of claim 10, wherein the unflavored liquor is selected from the group consisting of whiskey, bourbon, vodka, gin, rum, and brandy.

12. The method of claim 10, wherein the unflavored liquor is rested in the seasoned new oak barrel for at least three months to acquire the flavor imparted by the seasoned new oak barrel to form the additive free flavored liquor.

13. A method to produce an additive free flavored tequila, the method comprising:
resting an unflavored silver or Blanco tequila in a seasoned new oak barrel for at least a month to acquire a flavor imparted by the seasoned new oak barrel to produce the additive free flavored tequila.

14. The method of claim 13, wherein the method comprising resting the unflavored silver or Blanco tequila in the seasoned new oak barrel for less than two months to produce an additive free flavored silver or Blanco tequila.

15. The method of claim 13, wherein the method comprising resting the unflavored silver or Blanco tequila in the seasoned new oak barrel for at least two months and less than a year to produce an additive free flavored aged or reposado.

16. The method of claim 13 wherein the method comprising resting the unflavored silver or Blanco tequila in the seasoned new oak barrel for at least a year and less than three years to produce an additive free flavored extra-aged or Añejo tequila.

17. The method of claim 13, wherein the method comprising resting the unflavored silver or Blanco tequila in the seasoned new oak barrel for at least three years to produce an additive free flavored ultra-aged or Extra Añejo tequila.

18. The method of claim 13, further comprising filtering the additive free flavored tequila.

19. The method of claim 13, further comprising filling a new oak barrel with a seasoning solution and letting the seasoning solution resting in the new oak barrel for at least 10 days to season the new oak barrel to produce the seasoned new oak barrel, and the seasoning solution comprises a natural flavor selected from the group consisting of coffee flavor, strawberry flavor, tobacco flavor, watermelon flavor, vanilla flavor, grapefruit flavor, ginger flavor, bitters flavor, chocolate flavor, orange flavor, and lemon flavor.

20. The method of claim 19, wherein the new oak barrel is medium charred and the seasoning solution rests in the new medium charred oak barrel for 30 days at room temperature to season the new medium charred oak barrel to produce the seasoned new oak barrel.
